(19) United States
(12) Patent Application Publication
(10) Pub. No.: US 2012/0169154 A1
(43) Pub. Date: Jul. 5, 2012

(54) AXIAL-FLUX BRUSHLESS ELECTRIC MOTOR

(75) Inventor: Alain Curodeau, Quebec (CA)

(73) Assignee: ODOMOTION, INC., St.-Nicolas (CA)

(21) Appl. No.: 13/380,547

(22) PCT Filed: Jun. 23, 2009
(86) PCT No.: PCT/CA2009/000876

§ 371 Date: Mar. 23, 2012

(51) Int. Cl. H02K 3/04; H02K 7/14; H02K 5/02; H02K 5/22; H02K 9/22

(52) U.S. Cl. 310/43; 310/68 D; 310/52; 310/67 R

(57) ABSTRACT

An axial-flux brushless electric motor which can be used in various applications, including, for example, driving a propulsion wheel of a vehicle. In one embodiment, the electric motor comprises a rotor comprising a plurality of permanent magnets defining a plurality of rotor poles. The electric motor also comprises a stator axially spaced from the rotor and comprising: at least one winding for conducting current; an electronic controller for controlling the current supplied to the at least one winding to rotate the rotor; and consolidating material in which the at least one winding and the electronic controller are embedded.

### FIELD OF THE INVENTION

The invention relates to axial-flux electric motors.

### BACKGROUND

Various applications require or benefit from electric motors that are powerful yet light, produce high torque at low speed, and/or are highly efficient.

For example, bicycles can be equipped with electric motors for driving their wheels to provide electrical propulsion assistance. It is desirable that these electric motors deliver sufficient power yet remain as light as possible, while also provide high torque at low speed, all this in an efficient manner in view of limited power supplies carriable on bicycles.

Other types of vehicles, such as wheelchairs, scooters, electric or hybrid automobiles, ultralight aerial vehicles or unmanned aerial vehicles (UAVs), to name a few examples, may also require or benefit from light, powerful, high torque producing, and/or highly efficient electric motors. Applications other than vehicular ones (e.g., fans) may also require or benefit from such electric motors.

While electric motor technology has progressed over the years, there remains a need for improving electric motors, particularly in terms of power-to-weight ratio, torque production capability, and efficiency.

### SUMMARY OF THE INVENTION

According to a first broad aspect, the invention provides an axial-flux brushless electric motor. The electric motor comprises a rotor comprising a plurality of permanent magnets defining a plurality of rotor poles. The electric motor also comprises a stator axially spaced from the rotor and comprising: at least one winding for conducting current; an electronic controller for controlling the current supplied to the at least one winding to rotate the rotor; and consolidating material in which the at least one winding and the electronic controller are embedded.

According to a second broad aspect, the invention provides an axial-flux brushless electric motor. The electric motor comprises a stator comprising at least one winding for conducting current in a number Nₚ of phases, the at least one winding comprising a number N_{c} of radial conductors distributed around the stator in a plane, each radial conductor having a cross-section with a width w_{c} in a direction generally perpendicular to an axis of rotation of the axial-flux brushless electric motor, the at least one winding being characterized by a fill factor F_{f}. The electric motor also comprises a rotor axially spaced from the stator and comprising a plurality of permanent magnets defining a plurality of rotor poles, the permanent magnets being disposed in an annular configuration facing a side of the stator, the permanent magnets being distributed according to a magnet pitch pₘ such that

$${p}_{m} < \frac{3 {N}_{p} {w}_{c}}{{F}_{f}} .$$

According to a third broad aspect, the invention provides an axial-flux brushless electric motor. The electric motor comprises a stator comprising at least one winding for conducting current, each winding extending in a wavy pattern around the stator to form a plurality of radial conductors, each radial conductor having an oblong cross-section. The electric motor also comprises a rotor axially spaced from the stator and comprising a plurality of permanent magnets defining a plurality of rotor poles.

According to a fourth broad aspect, the invention provides an axial-flux brushless electric motor for driving a propulsion wheel of a vehicle. The electric motor comprises a main motor body comprising: a stator comprising at least one winding for conducting current; and a rotor axially spaced from the stator and comprising a plurality of permanent magnets defining a plurality of rotor poles. The stator and the rotor are configured such that the main motor body has a diameter-to-thickness aspect ratio of at least 6 and the axial-flux brushless electric motor has a power-to-weight ratio of at least 3 W/kg per volt of supply voltage.

According to a fifth broad aspect, the invention provides an axial-flux brushless electric motor for driving a propulsion wheel of a vehicle, the propulsion wheel comprising a rim. The electric motor comprises a main motor body comprising: a stator comprising at least one winding for conducting current; and a rotor axially spaced from the stator and comprising a plurality of permanent magnets defining a plurality of rotor poles. The main motor body is dimensioned such that, when the axial-flux brushless electric motor is mounted within the propulsion wheel, the main motor body is concealed by the rim along a radial viewing direction.

According to a sixth broad aspect, the invention provides an axial-flux brushless electric motor for driving a propulsion wheel of a vehicle, the propulsion wheel comprising a rim and a plurality of spokes projecting inwardly from the rim. The electric motor comprises a main motor body comprising: (i) a stator comprising at least one winding for conducting current; and (ii) a rotor axially spaced from the stator and comprising a plurality of permanent magnets defining a plurality of rotor poles. The electric motor also comprises a spoke attachment for attaching the spokes to the axial-flux brushless electric motor remotely from the main motor body.

According to a seventh broad aspect, the invention provides an axial-flux brushless electric motor for driving a wheel of a bicycle. The electric motor comprises a stator comprising at least one winding for conducting current, and a rotor axially spaced from the stator and comprising a plurality of permanent magnets defining a plurality of rotor poles. The electric motor also comprises a pedaling detector for detecting when a rider of the bicycle is pedaling. The pedaling detector comprises: (i) a stationary pedaling detector portion that is part of the stator, the stationary pedaling detector portion comprising a Hall effect sensor; and (ii) a rotatable pedaling detector portion for rotating with the rotor, the rotatable pedaling detector portion comprising a magnet producing a magnetic field detectable by the Hall effect sensor.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows a bicycle comprising an axial-flux brushless electric motor in accordance with an embodiment of the invention;

FIGS. 2 and 3 respectively show a perspective view and a radial view of a wheel of the bicycle within which is mounted the electric motor;

FIGS. 4 to 6 respectively show a perspective view, a radial view and an exploded view of the electric motor;

FIG. 7A shows a cross-sectional view of half of the electric motor, and FIG. 7B shows a schematic cross-sectional view of half of the electric motor;

FIGS. 8A, 8B and 9 respectively show a perspective view, a partial cross-sectional view and a radial view of a stator of the electric motor;

FIG. 10 shows a cross-sectional view of half of the stator;

FIG. 11 shows an arrangement of windings of the stator;

FIG. 12 shows a close-up view of part of the arrangement of windings of the stator;

FIG. 13 shows a portion of one winding of the stator;

FIGS. 14 and 15 respectively show a portion of one winding of the stator before and after a cold-forging operation;

FIG. 16 shows a cross-section of a radial conductor of one winding of the stator;

FIGS. 17A to 17E respectively show different cross-sections of radial conductors of a winding in other embodiments;

FIG. 18 shows permanent magnets of a rotor of the electric motor;

FIG. 19 shows a flange of a spoke attachment of the electric motor;

FIG. 20 shows a pedaling detector of the electric motor; and

FIGS. 21 and 22 respectively show the pedaling detector when a rider of the bicycle does not pedal and does pedal.

It is to be expressly understood that the description and drawings are only for the purpose of illustrating certain embodiments of the invention and are an aid for understanding. They are not intended to be a definition of the limits of the invention.

### DETAILED DESCRIPTION OF THE EMBODIMENTS

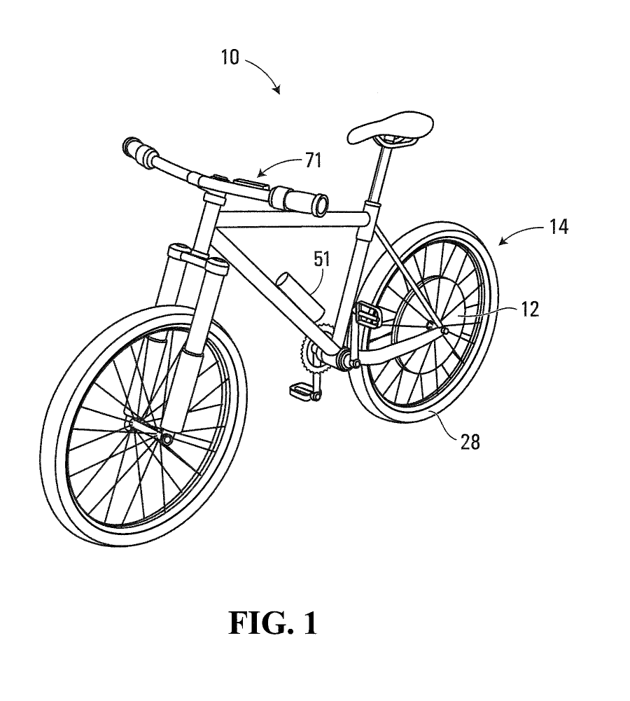

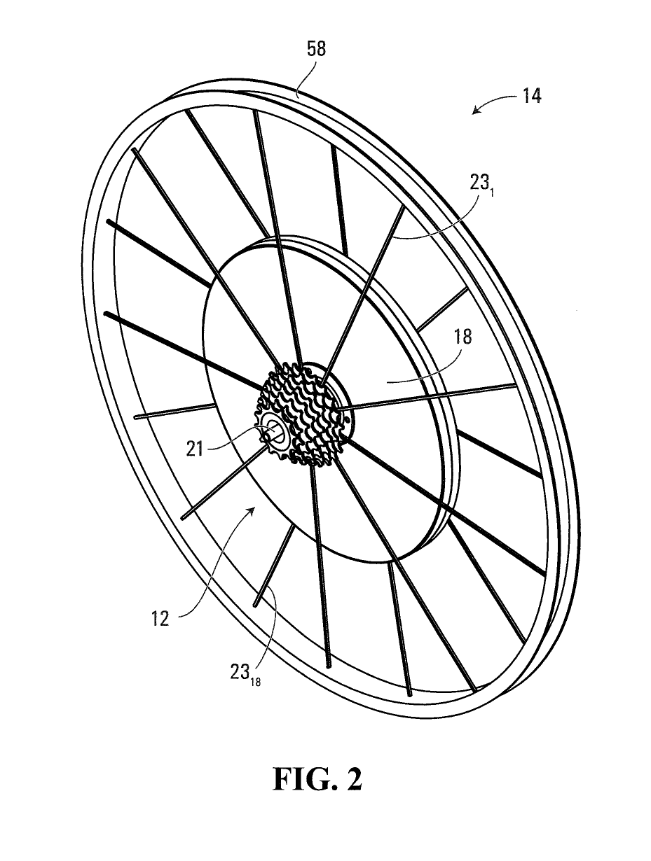

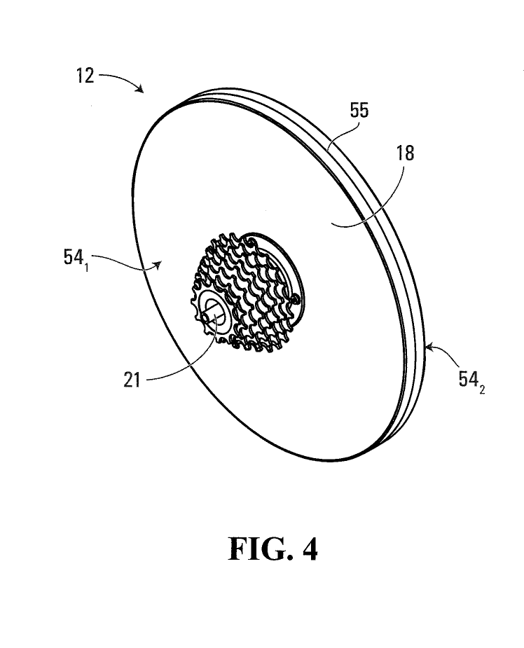

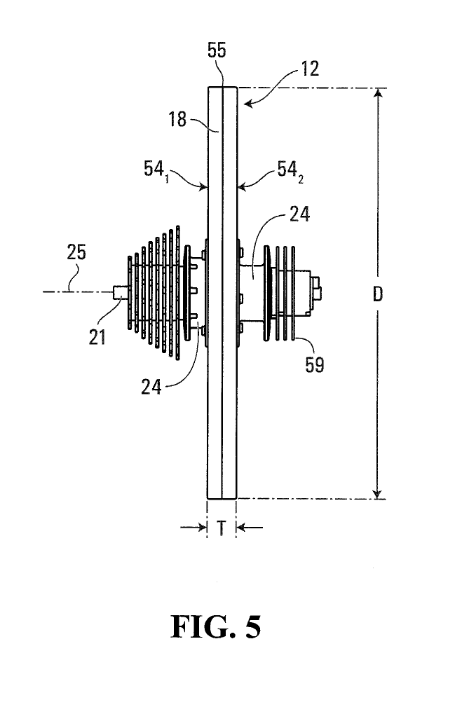

FIGS. 1 to 6 show a bicycle 10 comprising an axial-flux brushless electric motor 12 in accordance with an embodiment of the invention. In this embodiment, the electric motor 12 is mounted within a rear wheel 14 of the bicycle 10 for driving this rear wheel to provide electrical propulsion assistance to a rider of the bicycle 10. A power supply 51 (e.g., a battery or battery pack) is mounted to the bicycle 10 to supply power to the electric motor 12. A user interface 71 is connected to the electric motor 12 to enable the rider to control the electric motor 12 (e.g., activate it, deactivate it, and regulate a level of assistance provided by the electric motor 12).

The electric motor 12 comprises a main motor body 18, a central part 20 aligned with an axle 21, and a spoke attachment 24 to which are attached spokes 23₁-23₁₈ of the rear wheel 14.

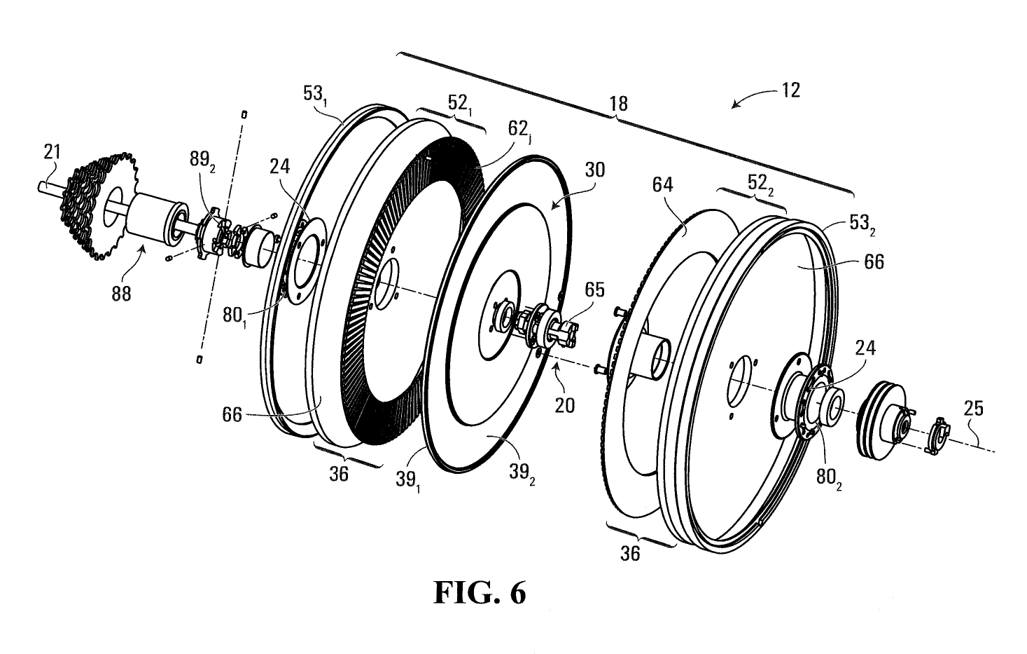

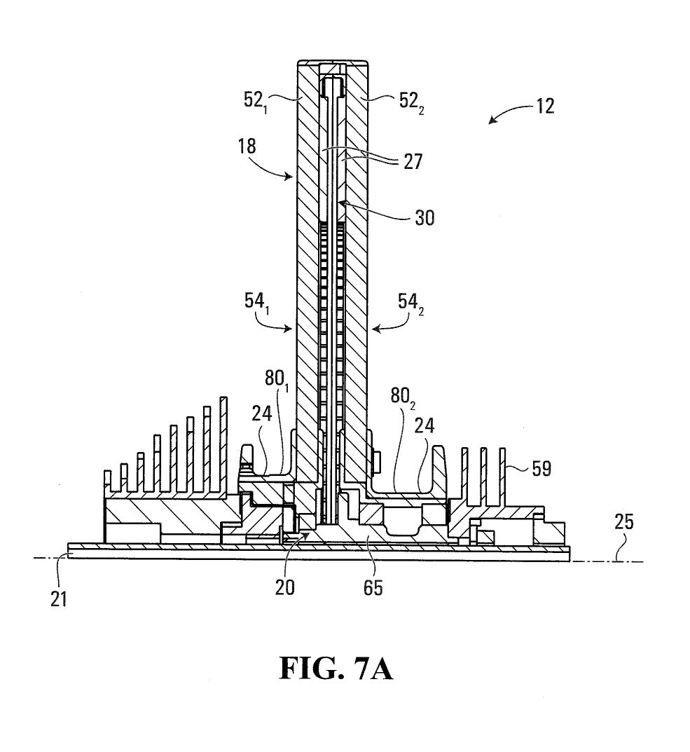

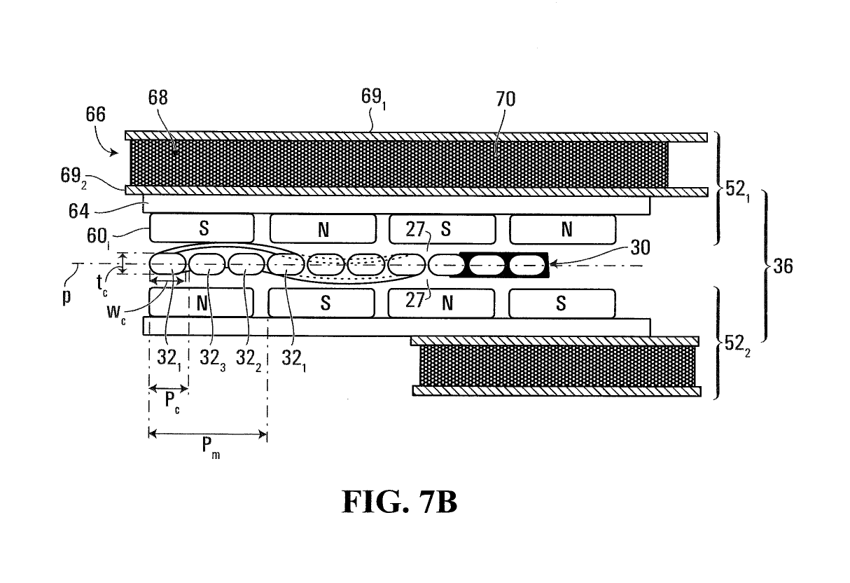

The main motor body 18 comprises a stator 30 and a rotor 36 that is rotatable about an axis of rotation 25, which is generally aligned with the axle 21. The stator 30 and the rotor 36 are axially spaced from one another (i.e., spaced from one another in a direction generally parallel to the axis of rotation 25) by a gap 27, as best shown in FIGS. 6, 7A and 7B. The electric motor 12 is an “axial-flux” electric motor in that magnetic flux through the gap 27 is generally parallel to the axis of rotation 25.

As further discussed below, the main motor body 18 implements a large number of poles, has a high diameter-to-thickness ratio, and is constructed in such a way that the electric motor 12 has a high power-to-weight ratio, produces high torque at low speed, and exhibits high efficiency.

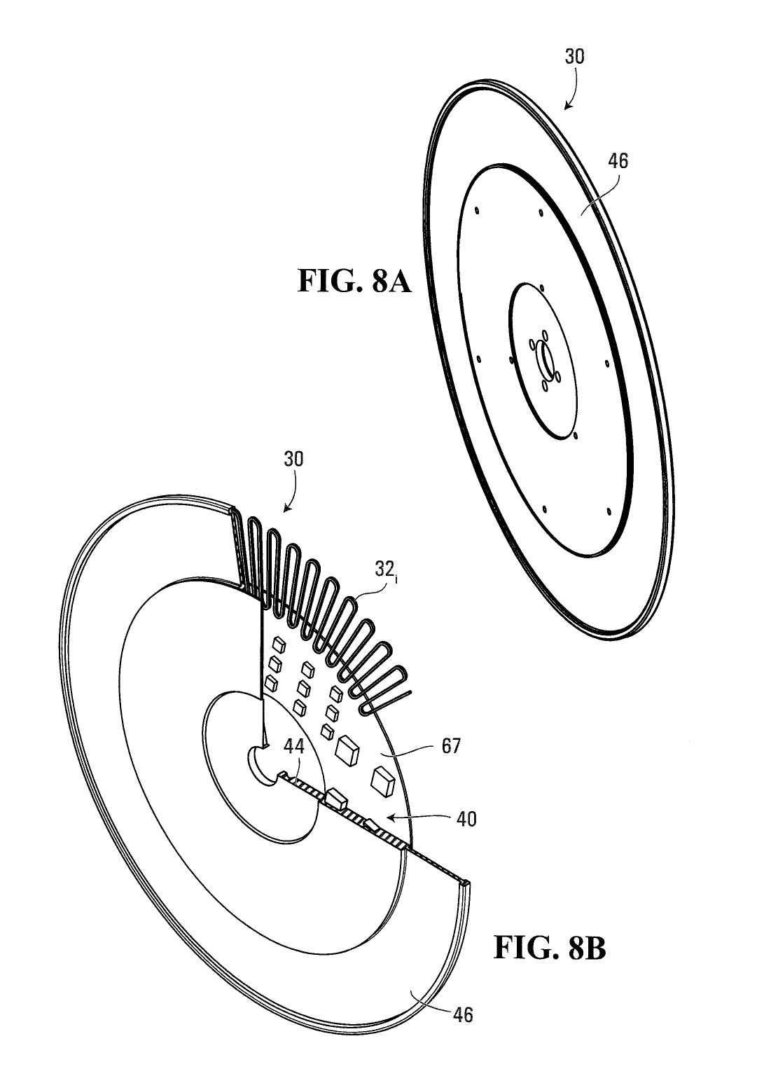

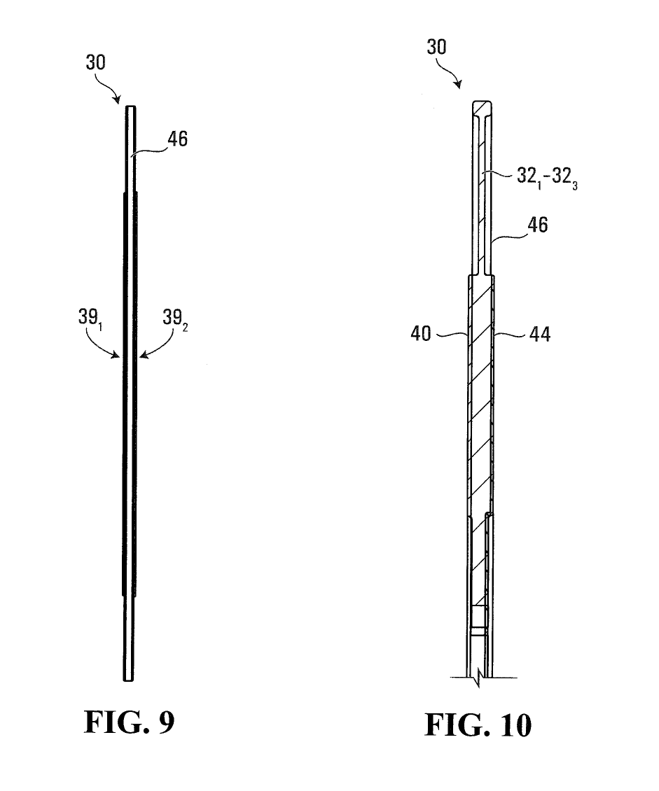

More particularly, in this embodiment, as best shown in FIGS. 6 and 8 to 11, the stator 30 comprises three (3) windings 32₁-32₃, an electronic controller 40, a heat sink 44, and consolidating material 46 in which the windings 32₁-32₃, the electronic controller 40 and the heat sink 44 are embedded.

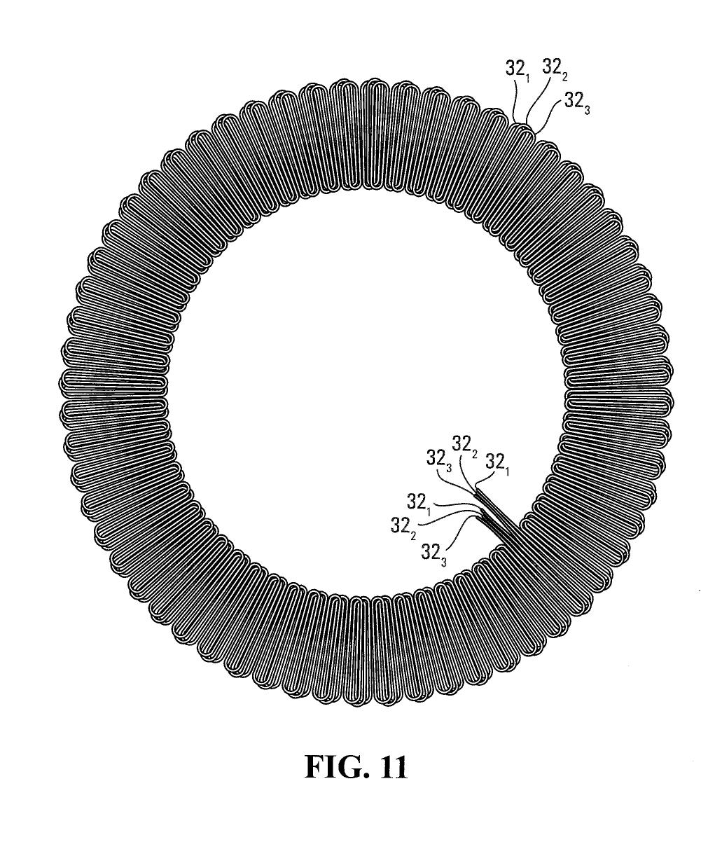

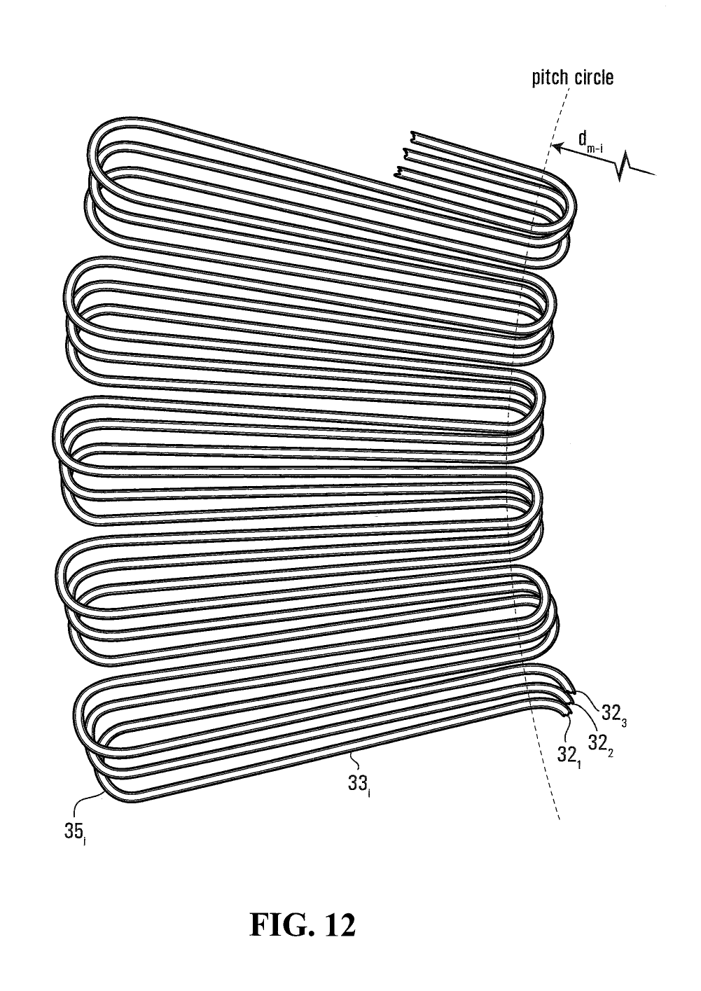

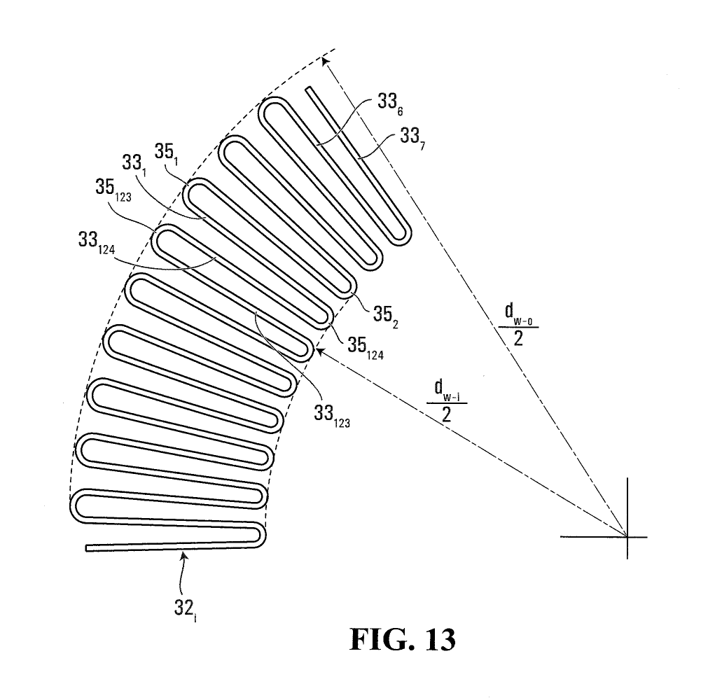

With additional reference to FIGS. 11 to 13, the windings 32₁-32₃ respectively conduct currents at three (3) phases that are spaced apart 120 electrical degrees. Each winding 32ᵢ (1≦i≦3) extends in a wavy pattern around the stator 30. The wavy pattern has an annular configuration with an inner diameter d_{w-i} and an outer diameter d_{w-o}.

With its wavy pattern, each winding 32ᵢ forms a plurality of radial conductors (sometimes also referred to as “coil sides”) 33₁-33₁₂₄ that are distributed around the stator 30 in a plane P and connected to one another via end-turn conductors 35₁-35₁₂₄. More particularly, in this embodiment, each winding 32ᵢ is a single-layer wave winding, i.e., a winding making a single turn around the stator 30 following a wavy pattern, such that all of its radial conductors 33₁-33₁₂₄ lie in the same plane P. In other embodiments, each winding 32ᵢ may be a multiple-layer winding that makes two (2) or more turns around the stator 30 following a wavy pattern, in which case its radial conductors may lie in two (2) or more planes (such as the plane P) that are generally parallel to one another and spaced from one another in a direction generally parallel to the axis of rotation 25.

As current flows through them, the radial conductors 33₁-33₁₂₄ of each winding 32ᵢ interact with magnetic fields produced by the rotor 36 to generate forces for rotation of the rotor 36. The radial conductors 33₁-33₁₂₄ of each winding 32ᵢ are therefore “working” conductors which contribute to torque generated by the electric motor 12. In contrast, the end-turn conductors 35₁-35₁₂₄ of each winding 32ᵢ can be viewed as “nonworking” conductors that complete a current path through the winding 32ᵢ. Thus, in this case, the windings 32₁-32₃ collectively form 372 radial conductors which produce torque as current flows through them and they interact with magnetic fields produced by the rotor 36.

The radial conductors 33₁-33₁₂₄ of the windings 32₁-32₃ are arranged around the stator 30 according to a radial conductor pitch p_{c}. The radial conductor pitch p_{c} refers to the distance, along a pitch circle, between corresponding points of successive ones of the radial conductors 33₁-33₁₂₄. As further discussed later, the pitch circle is defined by inner ends of permanent magnets of the rotor 36 and has a diameter dₘ₋ᵢ. In this case, the pitch circle passes through points at which the radial conductors 33₁-33₁₂₄ meet inner ones of the end-turn conductors 35₁-35₁₂₄. In other cases, the pitch circle may pass through other points of the windings 32₁-32₃.

Each winding 32ᵢ comprises a wire formed into the wavy pattern and having a cross-section dimensioned to allow a suitable current density. In this case, the wire is a solid wire. The solid wire may be made of copper, aluminum or other suitable metal. In other cases, the wire may be a stranded wire (e.g., a stranded wire with non-insulated individual strands or a Litz wire with insulated individual strands).

As shown in FIG. 16, the cross-section of each radial conductor 33ᵢ of each winding 32ᵢ has a width w_{c} in a direction generally perpendicular to the axis of rotation 25 and a thickness in a direction generally parallel to the axis of rotation 25. In this embodiment, the cross-section is oblong in that its width w_{c} is longer than its thickness t_{c} for minimizing the gap 27 between the stator 30 and the rotor 36 and increase a density of conducting material exposed to the magnetic field, thus enhancing the efficiency of the electric motor 12.

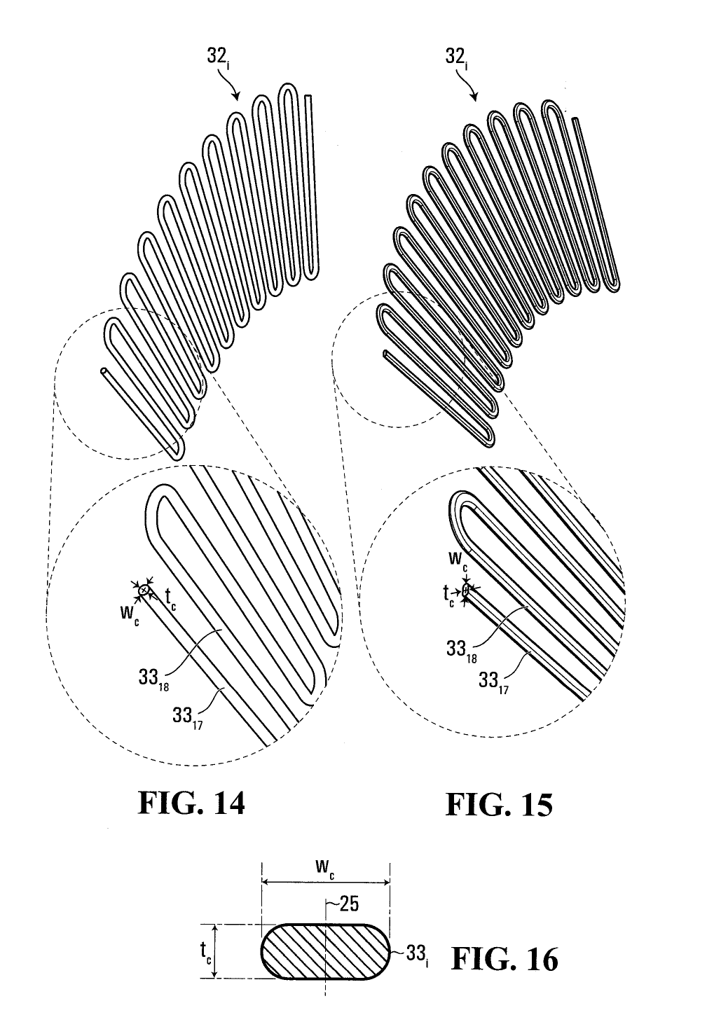

More particularly, in this embodiment, the cross-section of each radial conductor 33ᵢ of each winding 32ᵢ is produced by a cold-forging operation to obtain an oblong cross-section. For example, as shown in FIGS. 14 and 15, the oblong cross-section may be produced by cold-forging the winding 32ᵢ, which originally has a circular cross-section (i.e., its width w_{c} being substantially equal to its thickness t_{c}, namely its diameter), using a hydraulic press or other cold-forging equipment. In addition to allowing a reduction in size of the gap 27 and an increase in conducting material exposed to the magnetic field, the cold-forging operation induces cold-work hardening of the winding 32ᵢ which in turn makes it stronger.

For example, in one example of implementation, AWG 16 gauge round magnet wire with a heavy 130° C. Polyurethane-Nylon insulation may be used to create each of the windings 32₁-32₃. The original diameter of this wire is about 1.37 mm, and the wire may be used to produce a single-layer wave winding with an inner diameter d_{w-i} of 176 mm and an outer diameter d_{w-o} of 268 mm.

The winding produced above may then be placed within a 150 ton hydraulic press and sufficient pressure may be applied to reduce the thickness of the wire without tearing the insulation. As a result, the entire winding is flatten in one operation and the round wire is deformed to an oblong shape that is about 1 mm thick by 1.68 mm wide, which represents a 27% reduction in the thickness of this wire.

The reduction in the wire's thickness due to its oblong shape also reduces the size of the gap 27 in the electric motor 12. For example, assuming a single-layer wave winding and a required clearance of 0.8 mm from the rotor 36, a winding formed from the AWG 16 gauge magnet wire in its original round shape would require a gap of 2.97 mm (0.8 mm+1.37 mm+0.8 mm). In contrast, the above-referenced winding formed from the same wire in its deformed oblong shape results in a gap of 2.6 mm (0.8 mm+1.0 mm+0.8 mm), assuming the same clearance. Although the wire is the same in both windings, the oblong wire reduces the size of the gap 27 by 12.5%. This decrease may also increase the density of conducting material exposed to the magnetic field, which may also help enhance the overall efficiency of the electric motor 12. In addition, cold-forging the windings 32₁-32₃ in the manner described above may further enhance their structural rigidity by hardening the copper material within the wires.

The windings 32₁-32₃ are characterized by a fill factor F_{f} that indicates an extent to which they “fill” space with conducting material. Specifically, the fill factor F_{f} corresponds to a ratio of (1) the sum of the areas of the cross-sections of the radial conductors 33₁-33₁₂₄ of each winding 32ᵢ that lie in the plane P (at the pitch circle) over (2) an annular area equal to the circumference of the pitch circle multiplied by the thickness t_{c} of the cross-section of a given one of these radial conductors (at the pitch circle). Thus, in this embodiment, the fill factor F_{f} is given by:

$${F}_{f} = \frac{{N}_{c} {A}_{c}}{π {d}_{m \text{-} i} {t}_{c}}$$

where N_{c} is the number of radial conductors of the stator 30 that lie in the plane P, A_{c} is the area of the cross-section of each of these radial conductors, dₘ₋ᵢ is the diameter of the pitch circle, and t_{c} is the thickness of the cross-section of each of these radial conductors.

The fill factor F_{f} can take on various values in various embodiments, with higher values generally leading to better motor efficiency. For instance, in some embodiments, the fill factor F_{f} may be at least 0.4, preferably at least 0.6, and more preferably at least 0.8.

For example, in this embodiment, the stator 30 has 372 radial conductors which lie in the plane P (the 124 radial conductors 33₁-33₁₂₄ of each of the windings 32₁-32₃ all lie in the same plane P) such that N_{c}=372, the pitch circle has a diameter of 190 mm such that dₘ₋ᵢ=190 mm, and the cross-section of each radial conductor 33ᵢ of each of the windings 32₁-32₃ (with initial wire diameter of 1.37 mm) has a width of 1.55 mm and a thickness of 1.126 mm (after cold-forging) such that w_{c}=1.55 mm, t_{c}=1.126 mm and A_{c}≈1.47 mm² (where in this example

$${A}_{c} = \frac{π {t}_{c}^{2}}{4} + {t}_{c} ( {w}_{c} - {t}_{c} ) ) .$$

Thus, in this case, the fill factor F_{f} is 0.815.

It can be shown that the theoretical maximum fill factor for a winding made of wire (such as AWG 16 gauge magnet wire) that has a round shape is restrained to 78.5% for uniformly and orthogonally aligned wires. In contrast, the theoretical maximum fill factor for a winding made of round wire that has been cold-forged into an oblong shape is dependant on the degree of the wire's deformation from its previous round shape. For example, the theoretical maximum fill factor for wires can be found using the formula:

$${F}_{{f}_{max}} = \frac{1}{{f}^{2} ( \frac{4}{π} - 1 ) + 1}$$

where ƒ is the fraction of the wire's original diameter left in the direction in which it was cold-forged.

Using this formula, it can be calculated that the theoretical maximum fill factor for a winding formed from round wire is 78.5%. A 20% deformation (ƒ=0.8) of the round wire causes the theoretical maximum fill factor for the now oblong-shaped wire to increase to 85%, while a 50% deformation (ƒ=0.5) of the wire from its original shape causes the theoretical fill factor for the oblong wire to increase to 93.6%. Therefore, it may be seen that increases of up to 15% in the theoretical maximum fill factor may be achieved through plastic deformations of the round wire.

Although the above formula may be used to calculate a theoretical maximum fill factor, the actual fill factor is generally lower in practice due to random or imperfect wire arrangements. For example, the fill factor of a winding formed from round wire is typically in the range of 40% to 50%, while the fill factor for a winding formed from square wire (which should give a theoretical maximum fill factor close to 100%) is generally in the range of 70% to 80%.

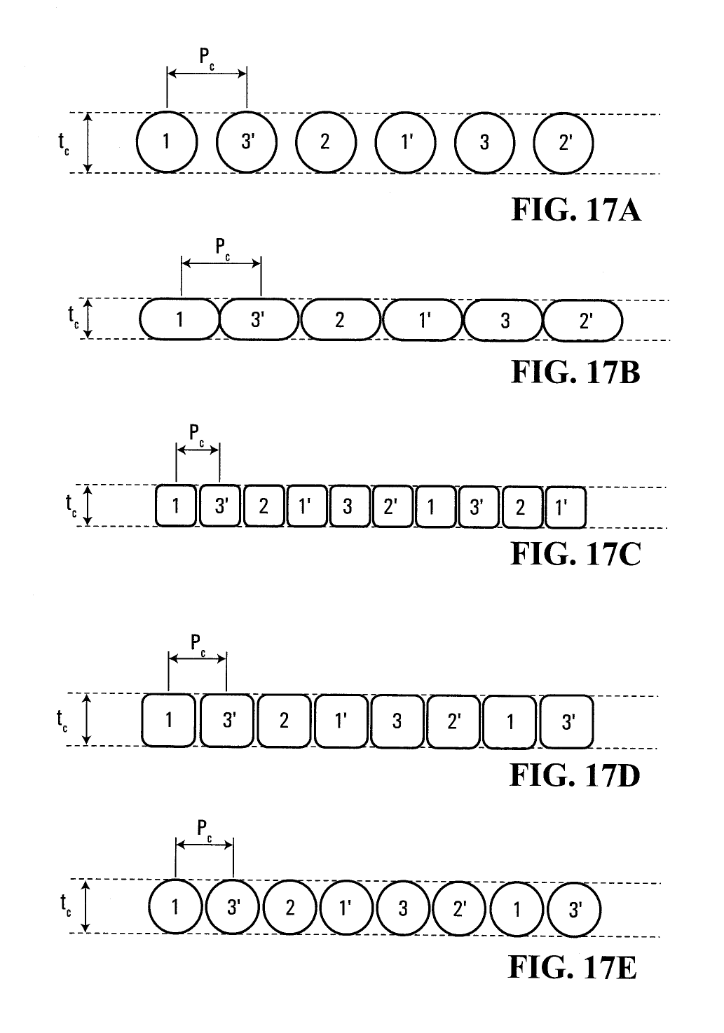

Therefore, it is possible that the actual fill factor for a winding formed from oblong-shaped wire should follow proportionally with respect to theoretical maximum values, although the theoretical maximum fill factor for such a winding may be within practical reach for single-layer windings. FIGS. 17A to 17E show the thickness and pitch for radial conductors in windings having various shapes. It may be seen that:

for wires whose cross-sectional areas are equal but whose shapes differ (such as those illustrated in FIGS. 17A, 17B and 17D), the thickness t_{c} of a winding made of round-shaped wire as shown in FIG. 17A is larger than the thickness t_{c} of a winding made of square-shaped wire as shown in FIG. 17D which is larger than the thickness t_{c} of a winding made of oblong-shaped wire as shown in FIG. 17B;

for wires whose cross-sectional areas are generally equal and radial conductor pitches p_{c} are generally equal (such as those illustrated by FIGS. 17A and 17B), the fill factor is higher for windings made of oblong-shaped wire as shown in FIG. 17B than for windings made of round-shaped wire as shown in FIG. 17A;

for wires whose thickness t_{c} is generally equal but whose radial conductor pitch p_{c} differ (such as those illustrated by FIGS. 17B and 17C), windings made from square-shaped wire as shown in FIG. 17C may have an equal or higher fill factor than windings made of oblong-shaped wire as shown in FIG. 17B. However, a winding made of square-shaped wire requires more turns since the radial conductor pitch p_{c} is lower than for windings made from oblong-shaped wires; and

for wires whose thickness t_{c} is generally equal and radial conductor pitch Pc is generally equal (such as those illustrated by FIGS. 17D and 17E), windings made of square-shaped wire as shown in FIG. 17D have a higher fill factor than windings made of round-shaped wire as shown in FIG. 17E.

The fill factor for single-layer wave windings made from originally round wires that have been imparted an oblong shape may thus fall both in theory and in practice somewhere between that of windings made from round wire and that of windings made from square wire.

The electronic controller 40 is configured for controlling current supplied to the windings 32₁-32₃ of the stator 30 in order to rotate the rotor 36. In particular, the electronic controller 40 implements an electronically-controlled commutation function to control the current in each of the windings 32₁-32₃. To that end, the electronic controller 40 may comprise a control unit controlling drivers and other power electronics which direct currents to the windings 32₁-32₃. For example, the control unit may comprise a logic circuit, a general-purpose processor, or an application-specific integrated circuit (ASIC). Various control techniques can be implemented by the electronic controller 40. For instance, in some embodiments, the electronic controller 40 may implement trapezoidal, sinusoidal or field oriented control (FOC) techniques.

As it directs rotation of the rotor 36, the electronic controller 40 implements a rotor orientation determination function to determine an orientation of the rotor 36 relative to the windings 32₁-32₃ of the stator 30. For example, in this embodiment, back electromotive force (EMF) in undriven ones of the windings 32₁-32₃ is used to infer the orientation of the rotor 36, eliminating the need for separate Hall effect sensors (i.e., sensorless monitoring). In other embodiments, Hall effect sensors or a rotary encoder may be provided to directly measure the orientation of the rotor 36.

In this embodiment, the electronic controller 40 comprises a printed circuit board (PCB) 67 on which its various electronic components are provided. The PCB 67 is embedded in the consolidating material 46 of the stator 30 such that the electronic controller 40, in addition to serving its control functionality, imparts structural rigidity to the stator 30. In other words, the electronic controller 40 is a structural member of the stator 30.

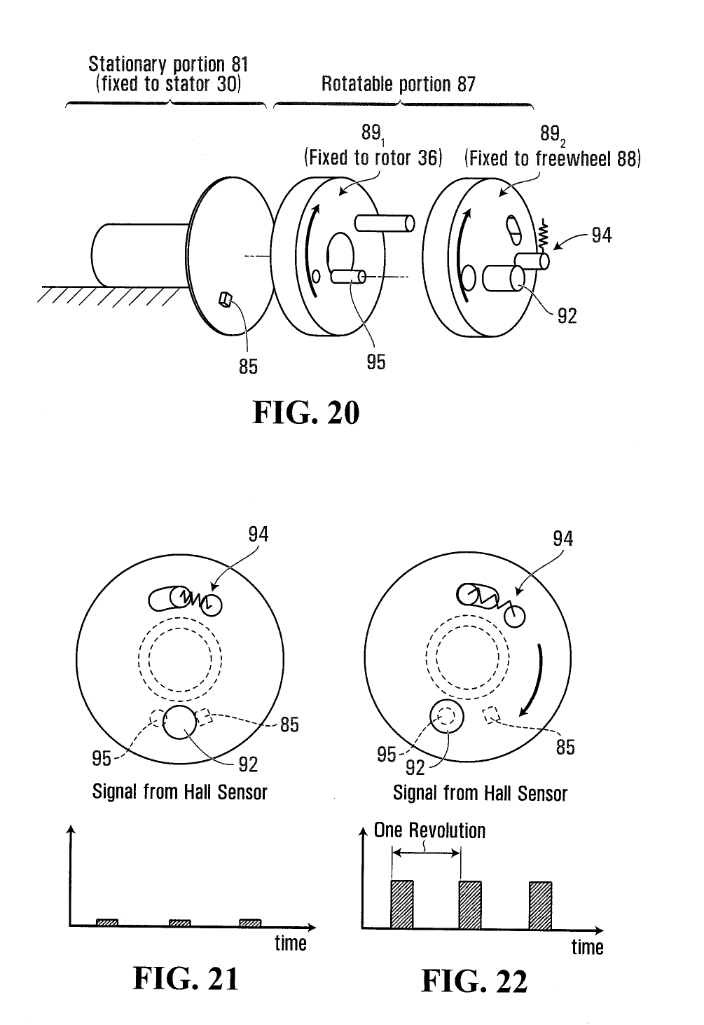

As further discussed later on, in this embodiment, the electric motor 12 comprises a pedaling detector to detect when the rider of the bicycle 10 is pedaling. As shown in FIG. 20, in this embodiment, the pedaling detector comprises a stationary pedaling detector portion 81 which is part of the stator 30 and which includes a Hall effect sensor 85 that is coupled to the control unit of the electronic controller 40.

The heat sink 44 contributes to dissipating heat generated by the windings 32₁-32₃ and the electronic controller 40. In this embodiment, the heat sink 44 comprises a thin metallic component (e.g., a sheet or plate). The thin metallic component may be made of aluminum, copper, magnesium, steel, silver or other suitable metal and alloys. In other embodiments, the heat sink 44 may be made of composite or other materials having suitable heat dissipation capacity. Heat generated by the windings 32₁-32₃ and the electronic controller 40 is conducted by the heat sink 44 to the axle 21 and a frame of the bicycle 10 and/or to the axle 21, bearings and an external heat sink 59 to finally escape to the surrounding environment as air is flowing around these components.

In this case, the heat sink 44 is embedded in the consolidating material 46 of the stator 30 such that the heat sink 44, in addition to serving its heat dissipation function, imparts structural rigidity to the stator 30. In other words, the heat sink 44 is a structural member of the stator 30.

The consolidating material 46 holds together the windings 32₁-32₃, the electronic controller 40 and the heat sink 44, which are embedded therein. More particularly, the consolidating material 46 is molded material in which are embedded all these components of the stator 30 such that the stator 30 is a molded monolithic part. For example, in some embodiments, the consolidating material 46 may comprise epoxy resin or other synthetic resin (which may contain one or more additions such as mineral fillers, flexibilizers, viscosity reducers, colorants, thickeners, accelerators, adhesion promoters, etc.) or composite material (e.g., a matrix with embedded reinforcements such as reinforcing fibers).

For example, in this embodiment, the electronic controller 40, which comprises the PCB 67, can be inserted within a mold together with the windings 32₁-32₃, the heat sink 44, and the stationary pedaling detector portion 81 of the pedaling detector prior to molding of the consolidating material 46, which in this example of implementation, comprises a thermally conductive compound. The molding of this compound in the mold consolidates and bonds these components together within a single unit that allows the use of the electronic controller 40 and the heat sink 44 as structural members within a composite sandwich assembly.

The thickness of the PCB 67 may take on various values to impart stiffness to the stator 30. For instance, the thickness of the PCB 67 may be in a range of 1 mm (or less) to 3 mm (or more). In addition, the tensile strength of the PCB 67 may be improved with a reinforcing material (e.g., fiberglass) and may also be backed by an aluminum sheet to improve dissipation of heat from the electronic controller 40.

Both the aluminum heat sink 44 and the electronic controller 40 can be assembled in such a way that these components lie significantly outside of the magnetic circuit in order to prevent eddy current losses, while still covering and/or intersecting inner ones of the end-turn conductors 35₁-35₁₂₄ of the windings 32₁-32₃ so that good mechanical and thermal connection between these components is provided.

Through such an assembly, the heat sink 44 and the electronic controller 40 can perform their primary function (namely, dissipating heat and controlling electric current to the stator 30, respectively), as well as act as structural members within the electric motor 12. Also, the stator 30 forms a single seamless and watertight assembly that protects its components against dirt and humidity while also simplifying the overall assembly of the electric motor 12.

The assembly of the stator 30 may be performed using a vacuum injection molding method, whereby a mold containing the windings 32₁-32₃, the electronic controller 40, the heat sink 44, and the stationary pedaling detector portion 81 of the pedaling detector is filled and impregnated with the consolidating material 46, which may contain reinforcing fibers such as fiberglass. The use of such a method minimizes the entrapped air while embedding these components within a rigid, watertight part.

One example of a procedure for constructing the stator 30 using the above-molding method includes:

applying the mold release to the mold surfaces;

inserting the electronic controller 40;

inserting one or two layers of 4 to 6 oz. fiberglass, Carbon or Kevlar cloth that covers the entire mold section;

inserting the windings 32₁-32₃ whose wires have been previously cold-forged as described earlier;

inserting the stationary pedaling detector portion 81 of the pedaling detector and a hollow axle component 65 for mounting to the axle 21;

soldering the windings 32₁-32₃, the stationary pedaling detector portion 81, and a power cord to the electronic controller 40;

optionally adding an additional lightweight solid core material (such as foam or balsa wood) around the electronic controller 40;

inserting another one or two layers of 4 to 6 oz. fiberglass, carbon or Kevlar cloth that covers the entire mold section;

inserting the heat sink 44;

closing the mold tightly;

securing the power cord and control serial wire outlets to prevent air leakage around these cables during molding;

preheating the mold to a temperature within a particular temperature range (e.g., 40° to 70° C.);

producing a vacuum level (e.g., a 250 to 700 mm Hg vacuum level) at the mold outlet in order to inject the consolidating material 46; and

injecting the consolidating material 46 into the mold.

In this example, the consolidating material 46 that is injected into the mold may comprise thermally conductive epoxy that comprises a solution and a hardener. The epoxy may contain alumina powder or carbon black, such as the Hysol 3142/3160 epoxy system from Loctite or the 832-TC epoxy system from MG Chemical.

The thermally conductive epoxy of the consolidating material 46 is prepared by combining the solution and hardener in a specified ratio, which is preferably degassed in a vacuum chamber. Since these types of epoxies are relatively viscous, the mold may be preheated to a temperature within a specified range, such as 40° to 70° C., before injection occurs. At the same time, the air pressure within the mold is lowered to a level in the range of 250 to 700 mm Hg to create a vacuum in the mold. The difference in air pressure between the mold inlet and outlet forces the prepared epoxy into the mold where it fills all hollow spaces and consolidates the various parts of the stator 30 into a single part once cured.

The layers of fiberglass, carbon or Kevlar cloth applied to both sides of the windings 32₁-32₃ may be provided as a protective layer against possible abrasion and/or interference between these components and other components, such as the rotor 36. In addition, these layers may help prevent short-circuits between adjacent wires (such as those of the windings 32₁-32₃) that may be exposed through accidental wear.

The hollow axle component 65 is molded integrally with the stator 30 in order to insure a precise planar arrangement. The terminal ends of the hollow axle component 65 may be threaded to be compatible with standard commercial bicycle parts and mechanisms, such as fixed or quick-release axles (like the axle 21), as well as freewheels.

The heat sink 44 may be made of a lightweight metal with good heat conductance and dissipation properties, such as aluminum. To improve the bond between the injected epoxy and the heat sink 44 when the stator 30 is formed, the aluminum may be coated with a bond-enhancing primer. Alternatively, the aluminum surface of the heat sink 44 may be sand-blasted or have notches or tongues cut into it to improve the bond between these two components. Through these methods, the aluminum-epoxy bonding strength can be improved.

This example procedure for constructing the stator 30 may include an optional step whereby a lightweight solid core material may be added between the electronic controller 40 and heat sink 44. The lightweight solid core material may include structural foam, carbon fiber, Kevlar fiber, fiberglass, balsa wood, or other lightweight materials. These materials may be added to further reduce the weight of the stator 30 since the injected epoxy (which is likely heavier than these core materials) cannot fill the space already occupied by these core materials.

The consolidating material 46 may include certain reinforcement fibers, such as fiberglass, that are embedded within the injected epoxy that is used to form the stator 30. These fibers can act as structural elements of the stator 30 both inside and outside of the magnetic path of permanent magnets of the rotor 26 and allow increased heat deflection for the entire part.

This arrangement helps to prevent the stator 30 from warping, as well as maintains its planarity during operation, which reduces the dimensional tolerance needed for the gap 27. This reduction in the size of the gap 27 may improve the overall efficiency of the electric motor 12 during operation.

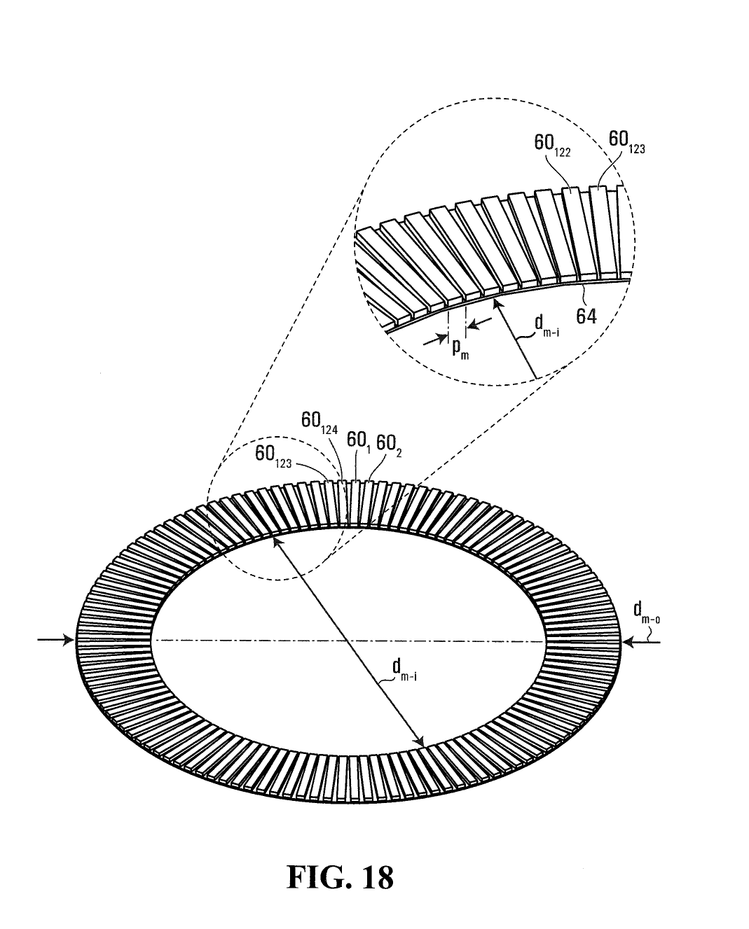

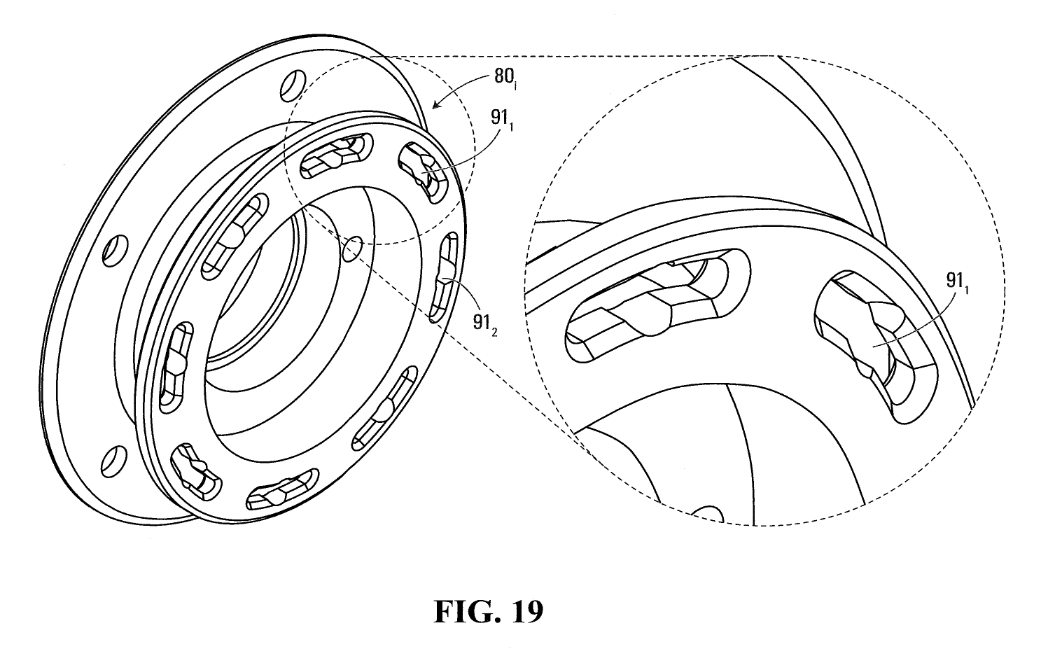

With reference to FIGS. 6, 7 and 18, in this embodiment, the rotor 36 comprises a first rotor portion 52₁ and a second rotor portion 52₂ that are positioned on respective sides 39₁, 39₂ of the stator 30. Each rotor portion 52ᵢ (1≦i≦2) comprises a plurality of permanent magnets 60₁-60₁₂₄ that are mounted to a magnet mounting part 64 of a rotor structure 66 and that face a given one of the sides 39₁, 39₂ of the stator 30.

The permanent magnets 62₁-62₁₂₄ of each rotor portion 52ᵢ define a plurality of rotor poles and may be made of various magnetic materials. For example, in this embodiment, the permanent magnets 62₁-62₁₂₄ of each rotor portion 52ᵢ are rare-earth magnets made from alloys of rare-earth elements. In other embodiments, the permanent magnets 62₁-62₁₂₄ may be made of other ferromagnetic materials, such as iron, nickel, cobalt, or alloys thereof (e.g., alnico), or other magnetic materials.

The rotors poles defined by the permanent magnets 62₁-62₁₂₄ may be arranged in various manners. For example, in this embodiment, individual ones of the permanent magnets 62₁-62₁₂₄ of each rotor portion 52ᵢ and the rotor poles they define are arranged as alternating “north” and “south” poles. In other embodiments, the permanent magnets of each rotor portion 52ᵢ may form a Halbach arrangement, such as a 90°-Halbach arrangement having two magnets for each pole, a 60°-Halbach arrangement having three magnets for each pole, or a 45°-Halbach arrangement having four magnets for each pole.

The permanent magnets 62₁-62₁₂₄ of each rotor portion 52ᵢ are distributed around the rotor 36 in an annular configuration with an inner diameter dₘ₋ᵢ and an outer diameter dₘ₋ₒ. The magnet mounting part 64 of the rotor portion 52ᵢ supports the permanent magnets 62₁-62₁₂₄ of the rotor portion 52ᵢ and, in this case, also provides a magnetic flux path. For example, in this embodiment, the magnet mounting portion 64 comprises a ring made of low carbon steel and can thus be referred to as a “back-iron”. In other embodiments, the magnet mounting part 64 may be made of various other materials.

More particularly, the permanent magnets 62₁-62₁₂₄ of each rotor portion 52ᵢ are distributed around the rotor 36 according to a magnet pitch pₘ. The magnet pitch pₘ refers to the distance, along the pitch circle, between corresponding points of successive ones of the permanent magnets 62₁-62₁₂₄. As mentioned previously, the pitch circle is defined by inner ends of the permanent magnets 62₁-62₁₂₄ such that it has a diameter corresponding to the inner diameter dₘ₋ᵢ of the annular configuration in which the permanent magnets 62₁-62₁₂₄ are arranged.

Providing a large number of permanent magnets in a relatively small space can enhance a power-to-weight ratio of the electric motor 12. For example, such large number of permanent magnets can help to minimize the weight of the magnet mounting part 64. It can thus be beneficial to have the magnet pitch pₘ as small as possible, taking into account physical constraints, such as space occupied by each winding of the stator 30, which is reflected by the fill factor F_{f} of the windings of the stator 30.

Accordingly, in some embodiments, the electric motor 12 can be designed to have the magnet pitch pₘ such that

$${p}_{m} < \frac{3 {N}_{p} {w}_{c}}{{F}_{f}} ,$$

preferably

$${p}_{m} \leq \frac{2 {N}_{p} {w}_{c}}{{F}_{f}} ,$$

and more preferably

$${p}_{m} \leq \frac{{N}_{p} {w}_{c}}{{F}_{f}} ,$$

where Nₚ is the number of phases of the stator 30 (i.e., the number of phases of current conducted in the windings of the stator 30), w_{c} is the width of the cross-section of each radial conductor 33ᵢ of the stator 30, and F_{f} is the fill factor of the windings of the stator 30.

For example, in this embodiment, the stator 30 has three phases (i.e., the different phase of current conducted by each of the windings 32₁-32₃) such that Nₚ=3, the cross-section of each radial conductor 33ᵢ of each of the windings 32₁-32₃ has a width of 1.55 mm such that w_{c}=1.55 mm, and the fill factor of the windings 32₁-32₃ is 0.815 (as previously shown) such that F_{f}=0.815. Thus, in this case, the permanent magnets 62₁-62₁₂₄ of each rotor portion 52ᵢ may be arranged such that the magnet pitch pₘ is less than 17.1 mm, preferably less than or equal to 11A mm, and more preferably less than or equal to 5.7 mm. In this particular example, the magnet pitch pₘ is 4.8 mm.

In some cases in which each of the windings 32₁-32₃ is made of a round wire that has been cold-forged into an oblong shape, the magnet pitch pₘ may be such that

$${p}_{m} < \frac{3 {N}_{p} {w}_{c}}{( {F}_{f} / {F}_{f max} )} ,$$

preferably

$${p}_{m} \leq \frac{2 {N}_{p} {w}_{c}}{( {F}_{f} / {F}_{f max} )} ,$$

and more preferably

$${p}_{m} \leq \frac{{N}_{p} {w}_{c}}{( {F}_{f} / {F}_{f max} )} ,$$

where F_{f max} is the theoretical maximum fill factor as discussed previously.

While designing the electric motor 12 based on the above criteria may be desirable in some embodiments, it is to be understood that the magnet pitch pₘ may deviate from such criteria in other embodiments.

The rotor structure 66 of each rotor portion 52ᵢ may be constructed in various ways. In this embodiment, the rotor structure 66 comprises an assembly of different materials to make the rotor portion 52ᵢ thin, light and strong. This contributes significantly to enhancing a power-to-weight ratio of the electric motor 12.

More particularly, in this embodiment, the rotor structure 66 comprises a sandwich structured composite 68 that includes a pair of skins 69₁, 69₂ attached on respective sides of a core 70. For instance, in some embodiments, the skins 69₁, 69₂ may be made of sheet metal (e.g., aluminum), glass or carbon fiber reinforced plastic, and/or other rigid materials. The core 70 may be made of structural foam, honeycomb material such as composite honeycomb (e.g., made of glass-, carbon fiber, nomex- or Kevlar-reinforced plastic), balsa, light metal (e.g., aluminum), and/or other lightweight material.

The permanent magnets 60₁-60₁₂₄ of each rotor portion 52ᵢ are mounted to the back-iron 64 which is then affixed to the rotor structure 66. The rotor portions 52₁, 52₂ are assembled with the stator 30 therebetween. In this case, annular parts 53₁, 53₂ are mounted to the rotor 36 to complete the main motor body 18.

In view of the foregoing, it will be appreciated that the main motor body 18 is relatively thin and light, while remaining rigid and able to produce relatively high power. In particular, the inner and outer diameters d_{w-i}, d_{w-o} of the annular configuration of each winding 32ᵢ, the inner and outer diameters dₘ₋ᵢ, dₘ₋ₒ of the annular configuration of the permanent magnets 62₁-62₁₂₄ of each rotor portion 52ᵢ, the large number of rotor poles within these annular configurations, the construction of the stator 30 using the electronic controller 42 and the heat sink 44 as structural members, and the construction of the rotor 36 using different materials contribute to the main motor body 18 having a large diameter-to-thickness ratio, a relatively low weight, and a relatively high power generation capability.

More specifically, the main rotor body 18 has a pair of outer sides 54₁, 54₂ opposite one another and an outer periphery 55. In this embodiment, the rotor structure 66 of each rotor portion 52ᵢ forms a respective one of the outer sides 54₁, 54₂ of the main motor body 18, and the annular parts 53₁, 53₂ form the outer periphery 55 of the main motor body 18.

The main motor body 18 has a diameter D defined by its outer periphery 55 and a thickness T defined by its outer sides 54₁, 54₂. In this case, since the outer sides 54₁, 54₂ are generally flat, the thickness T is generally constant. In some cases, the outer sides 54₁, 54₂ may not be flat but may rather be curved, jagged or otherwise shaped such that the thickness T varies. The diameter-to-thickness aspect ratio of the main motor body 18 refers to a ratio of the diameter D to the thickness T of the main motor body 18. In cases where the thickness T varies, the diameter-to-thickness aspect ratio is taken as the ratio of the diameter D to the minimum value of the thickness T.

It can be useful to construct the main motor body 18 based on principles discussed above such that the main motor body 18 has a diameter-to-thickness aspect ratio of at least 6, preferably at least 8, more preferably at least 10, and even more preferably at least 12. This can allow the electric motor 12 to have a high power-to-weight ratio, while being sufficiently thin to enable interesting mounting configurations of the electric motor 12 on the bicycle 10.

For example, in some embodiments, such high diameter-to-thickness aspect ratio of the main motor body 18 can allow the electric motor 12 to have a power-to-weight ratio of at least 3 W/kg and preferably at least 4 W/kg, per volt of supply voltage from the power supply 51. The power-to-weight ratio of the electric motor 12 refers to a ratio of continuous power deliverable by the electric motor 12 to the weight of the electric motor 12 per volt of voltage supplied to the electric motor 12. The continuous power refers to power that can be continuously delivered by the electric motor 12 for a prolonged period of time (e.g., at least 15 minutes) in a state in which the motor 12 can dissipate the heat generated by resistive losses in the windings 32₁-32₃ without overheating (e.g., temperature reaches a maximum steady state value below 70° C.-80° C.). This is in contrast to a peak power of the electric motor 12, which refers to transient power that can be delivered only for much shorter periods of time (e.g., 2 minutes or less) before the motor 12 overheats.

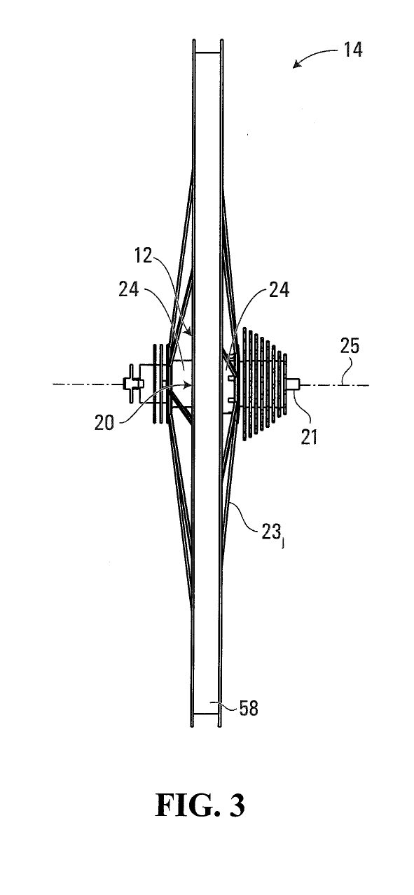

As another example, such high diameter-to-thickness aspect ratio of the main motor body 18 can allow the electric motor 12 to be mounted to the rear wheel 14 so that the main motor body 18 is concealed by a rim 58 of the rear wheel 14 along a radial viewing direction (as in FIG. 3). In other words, as shown in FIGS. 3 and 24, in these embodiments, the thickness T of the main motor body 18 (and specifically its maximum value in case it varies) is less than or equal to a thickness T_{R} of the rim 58 of the rear wheel 14. For example, in embodiments in which the rim 58 is a standard rim for which the thickness T_{R} is between 20 and 25 mm, the thickness T of the main motor body 18 can be less than or equal to this thickness value. Thus, when looking at the rear wheel 14 along a radial viewing direction, an observer would not see the main motor body 18, thereby enhancing aesthetics of the rear wheel 14 which would look much like a conventional wheel without any motor.

The spoke attachment 24 attaches the electric motor 12 to the spokes 23₁-23₁₈ of the rear wheel 14. In this embodiment, the spoke attachment 24 attaches the spokes 23₁-23₁₈ to the electric motor 12 remotely from the main motor body 18 (i.e., at points spaced from the main motor body 18). In this way, forces exerted on the spokes 23₁-23₁₈ during operation of the bicycle 10, such as forces due to weight of the rider and/or ground impacts or other effects, are diverted away from the main motor body 18 and towards the axle 21. As a result, the main motor body 18 can be made with lighter materials, thus contributing to reducing the weight of the electric motor 12.

More particularly, in this embodiment, as best shown in FIGS. 3 and 6, the spoke attachment 24 comprises a pair of flanges 80₁, 80₂ extending from respective ones of the outer sides 54₁, 54₂ of the main motor body 18 adjacent to the central part 20. In addition to diverting forces exerted on the spokes 23₁-23₁₈ away from the main motor body 18, the spokes 23₁-23₁₈ surround the main motor body 18 and thus act as a protection shield against occasional side impact with the surrounding environment.

The flanges 80₁, 80₂ are designed to facilitate mounting of the electric motor 12 to the spokes 23₁-23₁₈, especially if these spokes are standard spokes with a 90° elbow head. As shown in FIG. 19, each flange 80ᵢ (i=1 or 2) comprises slits 91₁-91₈ for mounting two or more of these spokes, such that each slit can be used to facilitate the mounting of two (2) or more spokes in the set of spokes 23₁-23₁₈. Each slit 91ᵢ (1≦i≦8) has a central enlargement dimensioned to be slightly larger than the head of an individual one of the spoke 23₁-23₁₈ to allow insertion of this head to the flange 80ᵢ for mounting. To mount a pair of spokes with a 90° elbow head, the head of a first spoke, say the spoke 23₁, is inserted to the central enlargement of the slit 91ᵢ such that the head of this spoke and its body lie on opposed sides of the flange 80ᵢ. The head of the spoke 23₁ is then moved to one of the terminal ends of the slit 91ᵢ so that the threaded end of this spoke may then be attached to the rim 58 through known means. The head of a second spoke, say the spoke 23₂, may then be inserted in a similar manner through the central enlargement of the slit 91ᵢ so that the spoke 23₂ can be moved to the end of the slit 91ᵢ opposite the spoke 23₁. This process is repeated to mount each pair of spokes in the set of spokes 23₁-23₁₈ until the motor 12 is mounted within and attached to the rim 58. This design allows the insertion of individual spokes on either side of each slit 91ᵢ in the flange 80ᵢ without interfering with the main motor body 18. Furthermore, this design allows the wheel 14 incorporating the electric motor 12 to be built, trued and maintained using standard spokes with a 90° elbow head.

With its electric motor 12, the bicycle 10 is one type of electric motorized bicycle (sometimes referred to as a light electric vehicle (LEV)) that can be operated in various modes, including a power-on-demand mode where the electric motor 12 is activated and controlled by the rider using the user interface 71 (e.g., a handlebar mounted throttle) and/or a pedelec mode where the electric motor 12 is activated and regulated by pedaling.

With additional reference to FIGS. 20 to 22, in order to operate in the pedelec mode, in this embodiment, the electric motor 12 comprises the pedaling detector to detect when the rider of the bicycle 10 is pedaling. In this case, the pedaling detector comprises the stationary pedaling detector portion 81 of the stator 30 and a rotatable pedaling detector portion 87 implemented by the rotor 36 and a freewheel 88.

The stationary pedaling detector portion 81 of the stator 30 comprises the Hall effect sensor 85 that can detect the magnetic field of a magnet 92 of the rotatable pedaling detector portion 87. In this example, the rotatable pedaling detector portion 87 comprises a first part 89₁ mounted to the rotor 36 (in this case, proximate the flange 80₁) and a second part 89₂ mounted to the freewheel 88. The first part 89₁ comprises a movable magnetic path 95 (e.g., a piece of iron or other magnetic material) and the second part 89₂ comprises the magnet 92. The first part 89₁ and the second part 89₂ are interconnected via a biasing mechanism 94. In this example, the biasing mechanism 94 comprises a spring coupled to the first part 89₁ and the second part 89₂.

When the rider does not pedal and does not apply pressure on the pedals, the biasing mechanism 94 biases the first part 89₁ and the second part 89₂ of the rotatable pedaling detector portion 87 to position the magnet 92 and the movable magnetic path 95 relative to one another such that the magnetic field of the magnet 92 is not channeled via the magnetic path 95. Such a situation is shown in FIG. 21. The Hall effect sensor 85 detects no or little change in magnetic field in this situation.

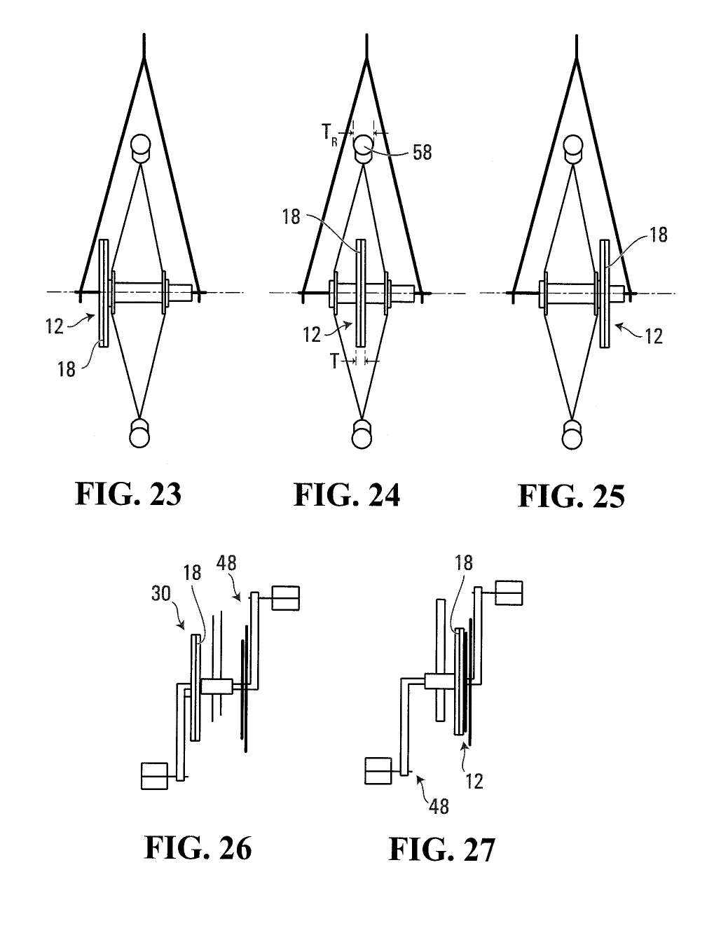

When the rider pedals, the rotatable pedaling detector portion 87 is rotated and the pressure applied by the rider on the pedals acts against the biasing mechanism 94, causing the magnet 92 and the movable magnetic path 95 to be positioned relative to one another such that the magnetic field of the magnet 92 is channeled via the magnetic path 95. Such a situation is shown in FIG. 22. As the magnet 92 and the magnetic path 95 repeatedly pass in front of it, the Hall effect sensor 85 repeatedly detects a substantial change in magnetic field.

As the Hall effect sensor 85 detects the increase in the level of magnetic flux, the stationary pedaling detector portion 81, which is connected to the control unit of the electronic controller 40 (e.g., through a wire or other link), can alert the electronic controller 40 that the rider is pedaling. The electronic controller 40 can thus supply power from the power supply 51 to the electric motor 12 such that the motor 12 provides the required assistance to the user.

When the rider stops pedaling (e.g., they are coasting down a hill), the biasing mechanism 94 biases the magnet 92 and the movable magnetic path 95 back to their default position relative to one another. In this position, the Hall effect sensor 85 no longer detects the substantial level of magnetic flux that is commensurate with the pedaling action of the rider and the electronic controller 40 may stop supplying power from the power supply 51 to the motor 12, which aborts the provision of assistance to the rider.

In other embodiments, the stationary pedaling detector portion 81 and the rotatable pedaling detector portion 87 may be configured to detect and provide assistance when the rider does not pedal. In this case, the conditions illustrated by FIGS. 21 and 22 are reversed, with FIG. 21 illustrating the position of the portion 87 when the rider is pedaling, while FIG. 22 illustrates the position of the portion 87 when the rider is not pedaling.

It will thus be appreciated that principles discussed herein allow the electric motor 12 to have a high power-to-weight ratio, produce high torque at low speed, and exhibit high efficiency.

For instance, in a specific example of implementation, the electric motor 12 was designed as a 250 W, 24V motor. This motor had a diameter D of 284 mm and a thickness T of 22 mm, which provided a 12.9 diameter-to-thickness aspect ratio. Furthermore, the small thickness T of this motor allows it to remain hidden within the profile of a standard 25 mm bicycle rim when such a wheel is seen from the front or rear.

In this example, the stator 30 has an outer diameter of 272 mm stator and comprised a 38 mm wide, single-layer outer ring segment with a 190 mm inner diameter d_{w-i} and a 266 mm outer diameter d_{w-o} having the three windings 32₁-32₃ formed from 15 AWG gauge copper wire with a 1.3 mm diameter. The heat sink 44 of the stator 30 was a 1 mm thick aluminum heat sink 190 mm in diameter. The electronic controller 40 comprised a 0.8 mm thick PCB. These components of the stator 30 were bound together with encapsulating epoxy to form a monolithic molded stator part.

A 5 mm radial overlap distance between the windings 32₁-32₃ and the heat sink 44 and the PCB of the electronic controller 40 was provided. This arrangement allowed the stator 30 to withstand much higher continuous electromagnetic forces along its periphery and so provide a higher continuous torque level. In particular, the electric motor 12 was able to provide a torque constant of about 0.5 Nm/A and a continuous torque output of about 6 Nm at 12 A. In addition, this arrangement allowed a more direct heat transfer path between the winding 32₁-32₃ end turn (outside the magnetic path) and the heat sink 44 provided more efficient heat removal.

Also, in this example, the rotor structure 66 of each rotor portion 52ᵢ was constructed from very thin, yet very rigid aluminum panels in a sandwich configuration with a honeycomb aluminum core. The rotor structure 66 was 6.35 mm thick.

The electric motor 12 weighed 2.2 kg and was able to provide approximately 250 W of continuous power from a 24 V power supply, which results in a power density of 114 W/kg at this supply voltage or a power-to-weight ratio of 4.7 W/kg per V of supply voltage. The weight could be reduced further by using other materials for each rotor portion 52ᵢ. For instance, the use of a fiberglass-Nomex honeycomb, a carbon fiber-Nomex honeycomb or a carbon fiber-Corecell honeycomb for the rotor structure 66 could yield weight savings that may increase the power density of the motor to 125 W/kg or more for the same supply voltage.

The electric motor 12 in this specific example of implementation provided generally better efficiency due to its ironless winding arrangement. In particular, the ironless winding arrangement allowed the reduction or elimination of eddy current losses and cogging that are currently observed with standard winding arrangements where copper wires are wound around an electrical steel core that is formed using powder metallurgy processes or by stacking silicon steel sheets together.

Also, since the stator 30 was ironless, the stator 30 and rotor 36 were not attracted to each other during assembly. This simplified the construction of the motor 12 and also allowed for the possibility of using less-rigid stator and rotor structural elements in the design of the motor 12 to achieve further weight savings.

The relatively large diameter of the electric motor 12 in this specific example of implementation allowed the motor 12 to increase the amount of torque provided at low rotational speeds. In addition, the diameter of the motor 12 provided a relatively large surface area that was more efficient at dissipating the heat generated by the electronic controller 30 and/or the windings 32₁-32₃.

Furthermore, the ability to deliver torque at low rotational speeds eliminates the need for a geared transmission, which further reduces the weight and cost of the motor 12, as well as simplifies its assembly.

While the electric motor 12 is configured in a particular way in this embodiment, the electric motor 12 may be configured in various other ways in other embodiments.

For example, in other embodiments, the stator 30 may comprise any other number of windings such as the windings 32₁-32₃ (e.g., only one winding, two windings, or more than three windings). Also, each winding of the stator 30 may extend around the stator 30 in a different wavy pattern (e.g., with a larger or smaller “wavelength”).

As another example, while in this embodiment the windings 32₁-32₃ respectively conduct currents at three phases spaced apart by 120 electrical degrees, in other embodiments, the windings of the stator 30 may conduct current at any other number of phases (e.g., a single phase, two phases, or more than three phases). Also, while in this embodiment the stator 30 comprises only one winding per phase of current, in other embodiments, the stator 30 may comprise two or more windings per phase of current. In such embodiments, the two or more windings per phase of current may lie in a common plane (such as the plane P) or in two or more planes generally parallel to one another and spaced apart in a direction generally parallel to the axis of rotation 25.

As yet another example, in other embodiments, the windings of the stator 30 may define any other large number of radial conductors depending on power, weight and size requirements of the electric motor 12. For example, in some embodiments, each of the windings of the stator 30 may define, in one turn around the stator 30, at least 50 radial conductors, preferably at least 75 radial conductors, and more preferably at least 100 radial conductors.

As yet another example, in other embodiments, the rotor 36 may comprise any other large number of permanent magnets defining any other large number of rotor poles depending on power, weight and size requirements of the electric motor 12. For example, in some embodiments, each rotor portion of the rotor 36 may comprise at least 50 rotor poles, preferably at least 75 rotor poles, and more preferably at least 100 rotor poles.

As yet another example, in other embodiments, each winding 32ᵢ of the stator 30 may have an oblong cross-section that has not been cold-forged into shape but rather formed using a drawing operation or another forming operation. For instance, in some embodiments, each winding 32ᵢ may comprise a wire having a rectangular cross-section or other oblong cross-section produced by drawing the wire through a correspondingly-shaped die. In other embodiments, each winding 32ᵢ of the stator 30 may not have an oblong cross-section but may rather have a circular, square or other non-oblong cross section whose width w_{c} and thickness t_{c} are substantially equal. For instance, in some embodiments, each winding 32ᵢ may comprise a wire having a round cross-section (in which case its width w_{c} and thickness t_{c} each corresponds to a diameter of the round cross-section).

As yet another example, in other embodiments, the stator 30 may be in a form other than a molded monolithic part. For instance, in some embodiments, instead of being held together by the consolidating material 46, one or more of the windings 32₁-32₃, the electronic controller 40 and the heat sink 44 may be held together by one or more mechanical fasteners (e.g., screws, rivets, soldering, etc.), possibly on one or more stator structural members.

As yet another example, in other embodiments, instead of comprising an assembly of different materials, the rotor structure 66 of each rotor portion 52ᵢ may be constructed from a single material (e.g., a single molded plastic piece).

As yet another example, in other embodiments, instead of comprising the two rotor portions 52₁, 52₂ with respective sets of permanent magnets 60₁-60₁₂₄ facing the two opposite sides 39₁, 39₂ of the stator 30, the rotor 36 may comprise a single rotor portion with permanent magnets that faces only one of the sides 39₁, 39₂ of the stator 30. For instance, in some embodiments, the rotor portion 52₁ may comprise the permanent magnets 60₁-60₁₂₄ as described above, while the rotor portion 52₂ may not comprise any permanent magnets. In such cases, the rotor portion 52₂ may comprise an annular back iron or other portion providing a magnetic flux path that is generally aligned with the permanent magnets 60₁-60₁₂₄ of the rotor portion 52₁. As another alternative, in some embodiments, the rotor portion 52₁ may comprise the permanent magnets 60₁-60₁₂₄ as described above, while the rotor portion 52₂ may be omitted altogether.

As yet another example, in other embodiments, the spoke attachment 24 may attach the electric motor 12 to the spokes 23₁-23₁₈ of the rear wheel 14 in various other manners. For example, in some embodiments, the spoke attachment 24 may attach the spokes 23₁-23₁₈ to the electric motor 12 at points located on the main motor body 18, such as points on the outer sides 54₁, 54₂ near the outer periphery 55.

As yet another example, in other embodiments, the rear wheel 14 may not have any spokes in which case the outer sides 54₁, 54₂ may extend up to the rim 58 of the rear wheel 14 (e.g., in the case of an integrated carbon wheel and rim.)

While in this embodiment the electric motor 12 is mounted inside the spokes 23₁-23₁₈ of the rear wheel 14 as part of the wheel's hub to drive the rear wheel 14, the electric motor 12 may be mounted to the bicycle 10 in various other manners, particularly in light of its thin shape, to directly or indirectly drive either the rear wheel 14 or a front wheel 15 of the bicycle 10.

For example, in some embodiments, the electric motor 12, and in particular, the main motor body 18, may be mounted on the left or right side of the hub, as shown by FIGS. 23 and 25, respectively. FIG. 23 shows the main motor body 18 mounted on the side of the hub opposite the freewheel or freewheel cluster, which is traditionally the left side of the hub as seen from the rear. In this configuration, the main motor body 18 may be integrated into the braking system of the bicycle 10, such as when the bicycle 10 is equipped with hydraulic disk brakes. In this case, the braking surface of a rotating portion of the hydraulic disk brake would be attached to the circumference of the main motor body 18, such as though the flanges 80ᵢ. Alternatively, the electric motor 12 may also be attached to the rim 58, even though the main motor body 18 is offset to the left side. In this case, the electric motor 12 may include a single flange 80ᵢ that is located on the side of the body 18 closest to the hub. The rear wheel 14 can thus be built by attaching a first subset of the spokes 23₁-23₁₈ to the rim 58 via the holes on the regular hub flange and attaching the remaining spokes to the rim 58 using the slits in the flange 80ᵢ. FIG. 25 shows the main motor body 18 mounted to the right side of the hub, such as in the space between the hub and the freewheel or freewheel cluster. In this configuration, the electric motor 12 may remain attached to the rim 58, albeit only on one side. The main motor body 18 in this configuration may also act as a chain protector that prevents the chain from slipping off the freewheel or off of the most proximate freewheel (i.e., the largest freewheel) in a cluster of freewheels.

The mounting configurations of the electric motor 12 that are shown in FIGS. 23, 24 and 25 may apply equally well to the front wheel 15 of the bicycle 10 as well. In particular, the main motor body 18 may be mounted centrally within the spokes 23₁-23₁₈ of the front wheel 15 as seen in FIG. 24, mounted at the left side of the hub as seen in FIG. 23, or mounted along the right side of the hub as seen in FIG. 25.

In other embodiments, the electric motor 12 may be mounted to other power train components of the bicycle 10. For example, in some embodiments, as shown FIGS. 26 and 27, the electric motor 12 may be coupled to a crank gear 48, which includes pedals, crank arms, a crank axle, a chain, front chain rings and/or other components that transmit power supplied by the rider via the pedals to the freewheel attached to the rear wheel 14, which drive the bicycle 14 forward. FIG. 26 shows an embodiment where the electric motor 12 and in particular, the main motor body 18, can be mounted along the side of the crank gear 48 that is opposite the front chain rings. FIG. 27 shows an embodiment where the electric motor 12 can be mounted along the same side of the crank gear 48 where the front chain rings are typically located.

While in this embodiment the electric motor 12 is used to drive a propulsion wheel (in this case, the rear wheel 14) of the bicycle 10, electric motors designed based on principles discussed herein may be used to drive other types of propulsion wheels of other types of vehicles. For example, in some embodiments, electric motors designed based on principles discussed herein may be used to drive propulsion wheels of wheelchairs, scooters, and electric or hybrid automobiles. In various cases, depending on the type of vehicle and propulsion wheel, an electric motor designed based on principles discussed herein may directly drive the propulsion wheel or may indirectly drive (i.e., drive via a power transmission mechanism (e.g., a gear, chain, belt, etc.)) the propulsion wheel.

In other embodiments, electric motors designed based on principles discussed herein may be used for purposes other than driving vehicular propulsion wheels. For example, in some embodiments, electric motors designed based on principles discussed herein may be used in ultralight aerial vehicles or unmanned aerial vehicles (UAVs), electric pedal boats, fans, and other applications requiring or benefiting from electric motors that are powerful and light, produce high torque at low speed, and/or are highly efficient.

Although various embodiments and examples have been presented, this was for the purpose of describing, but not limiting, the invention. Various modifications and enhancements will become apparent to those of ordinary skill in the art and are within the scope of the invention, which is defined by the appended claims.

1-53. (canceled)

54. An axial-flux brushless electric motor comprising:
(a) a rotor comprising a plurality of permanent magnets defining a plurality of rotor poles; and
(b) a stator axially spaced from the rotor and comprising:
at least one winding for conducting current;
an electronic controller for controlling the current supplied to the at least one winding to rotate the rotor; and
consolidating material holding together the at least one winding and the electronic controller.

55. The axial-flux brushless electric motor of claim 54, wherein each winding comprises at least 75 radial conductors distributed around the stator.

56. The axial-flux brushless electric motor of claim 54, wherein each winding comprises a plurality of radial conductors distributed around the stator, each radial conductor having an oblong cross-section.

57. The axial-flux brushless electric motor of claim 56, wherein the oblong cross-section is a rectangular cross-section.

58. The axial-flux brushless electric motor of claim 56, wherein the oblong cross-section is produced by a cold-forging operation.

59. The axial-flux brushless electric motor of claim 54, wherein the at least one winding is a plurality of windings for conducting a plurality of currents in different phases.

60. The axial-flux brushless electric motor of claim 54, wherein each winding comprises a wire formed into a wavy pattern.

61. The axial-flux brushless electric motor of claim 54, wherein the electronic controller comprises a printed circuit board, the printed circuit board imparting structural rigidity to the stator.

62. The axial-flux brushless electric motor of claim 54, wherein the stator comprises a heat sink for dissipating heat generated by the at least one winding and the electronic controller, the consolidating material holding together the at least one winding, the electronic controller and the heat sink.

63. The axial-flux brushless electric motor of claim 62, wherein the heat sink comprises a thermally conductive sheet or plate, the thermally conductive sheet or plate imparting structural rigidity to the stator.

64. The axial-flux brushless electric motor of claim 54, wherein the consolidating material comprises a synthetic resin.

65. The axial-flux brushless electric motor of claim 54, wherein the consolidating material comprises composite material.

66. The axial-flux brushless electric motor of claim 54, wherein the consolidating material comprises molded material.

67. The axial-flux brushless electric motor of claim 54, wherein the at least one winding and the electronic controller are embedded in the consolidating material.

68. The axial-flux brushless electric motor of claim 54, wherein:
the at least one winding is for conducting current in a number Nₚ of phases, the at least one winding comprising a number N_{c} of radial conductors distributed around the stator in a plane, each radial conductor having a cross-section with a width w_{c} in a direction generally perpendicular to an axis of rotation of the axial-flux brushless electric motor, the at least one winding being characterized by a fill factor F_{ƒ}; and
the plurality of permanent magnets is a number Nₘ of permanent magnets disposed in an annular configuration facing a side of the stator, the permanent magnets being distributed according to a magnet pitch pₘ such
that
$${p}_{m} < \frac{3 {N}_{p} {w}_{c}}{{F}_{f}} .$$

69. The axial-flux brushless electric motor of claim 68, wherein the magnet pitch pₘ is such that
$${p}_{m} \leq \frac{2 {N}_{p} {w}_{c}}{{F}_{f}} .$$

70. The axial-flux brushless electric motor of claim 54, wherein the rotor comprises a first rotor portion and a second rotor portion that are positioned on opposite sides of the stator, the permanent magnets being part of the first rotor portion.

71. The axial-flux brushless electric motor of claim 70, wherein the plurality of permanent magnets is a first plurality of permanent magnets, the second rotor portion comprising a second plurality of permanent magnets.

72. The axial-flux brushless electric motor of claim 54, wherein the plurality of permanent magnets faces a side of the stator and comprises at least 50 permanent magnets.

73. The axial-flux brushless electric motor of claim 54, comprising a main motor body that comprises the rotor and the stator and that has a diameter-to-thickness aspect ratio of at least 6.

74. The axial-flux brushless electric motor of claim 54, wherein the axial-flux brushless electric motor has a power-to-weight ratio of at least 3 W/kg per volt of supply voltage.

75. The axial-flux brushless electric motor of claim 54, wherein the axial-flux brushless electric motor is mountable within a propulsion wheel of a vehicle, the propulsion wheel comprising a rim, the axial-flux brushless electric motor comprising a main motor body that comprises the rotor and the stator, the main motor body being dimensioned such that, when the axial-flux brushless electric motor is mounted within the propulsion wheel, the main motor body is concealed by the rim along a radial viewing direction.

76. The axial-flux brushless electric motor of claim 54, wherein the axial-flux brushless electric motor is mountable within a propulsion wheel of a vehicle, the propulsion wheel comprising a rim and a plurality of spokes, the axial-flux brushless electric motor comprising: (i) a main motor body comprising the rotor and the stator; and (ii) a spoke attachment for attaching the spokes to the axial-flux brushless electric motor remotely from the main motor body.

77. The axial-flux brushless electric motor of claim 54, wherein the axial-flux brushless electric motor is mountable to a bicycle for driving a wheel of the bicycle, the axial-flux brushless electric motor comprising a pedaling detector for detecting when a rider of the bicycle is pedaling.

78. The axial-flux brushless electric motor of claim 54, wherein the axial-flux brushless electric motor is mountable to a vehicle for driving a propulsion wheel of the vehicle.

79. The axial-flux brushless electric motor of claim 78, wherein the vehicle is a bicycle.

80. An axial-flux brushless electric motor comprising:
(a) a stator comprising at least one winding for conducting current in a number Nₚ of phases, the at least one winding comprising a number N_{c} of radial conductors distributed around the stator in a plane, each radial conductor having a cross-section with a width w_{c} in a direction generally perpendicular to an axis of rotation of the axial-flux brushless electric motor, the at least one winding being characterized by a fill factor F_{ƒ}; and
(b) a rotor axially spaced from the stator and comprising a plurality of permanent magnets defining a plurality of rotor poles, the permanent magnets being disposed in an annular configuration facing a side of the stator, the permanent magnets being distributed according to a magnet pitch pₘ such that
$${p}_{m} < \frac{3 {N}_{p} {w}_{c}}{{F}_{f}} .$$

81. An axial-flux brushless electric motor for driving a propulsion wheel of a vehicle, the propulsion wheel comprising a rim, the axial-flux brushless electric motor comprising a main motor body comprising:
(a) a stator comprising at least one winding for conducting current; and
(b) a rotor axially spaced from the stator and comprising a plurality of permanent magnets defining a plurality of rotor poles;
wherein the main motor body is dimensioned such that, when the axial-flux brushless electric motor is mounted within the propulsion wheel, the main motor body is concealed by the rim along a radial viewing direction.
